(19) United States
(12) Patent Application Publication
(10) Pub. No.: US 2020/0167823 A1
(43) Pub. Date: May 28, 2020

(54) SHORT RANGE ADVERTISING SYSTEM

(71) Applicant: Trinity Proximity, Sulphur Springs, TX (US)

(72) Inventor: Shawn Whitson, Sulphur Springs, TX (US)

(21) Appl. No.: 16/611,093

(22) PCT Filed: May 4, 2018
(86) PCT No.: PCT/US18/31221

§ 371 Date: Nov. 5, 2019

Related U.S. Application Data
(60) Provisional application No. 62/501,914, filed on May 5, 2017.

(51) Int. Cl. G06Q 30/02; G06F 8/61; H04W 4/23; H04W 4/80

(52) U.S. Cl. CPC G06Q 30/0261; G06F 8/61; H04W 4/80; G06Q 30/0276; H04W 4/23

(57) ABSTRACT

Aspects of an advertising system are disclosed herein. In one example there is disclosed an advertising system. The system includes at least a short-range communication beacon associated with at least one business; and an advertisement (ad) generator, the ad generator comprising a user interface for receiving advertising inputs from the at least one business, the advertising inputs at least including promotional information about the business; a processor configured to generate at least one advertisement (ad) for the at least one business based on the promotional information; and a communication interface configured to receive a signal that includes at least one identifier of the short-range transmitter proximate a mobile communication device and associated with the at least one business. The communication interface sends at least one generated ad to the mobile communication device, based on the received transmitter identifier, for display thereon.

### CROSS-REFERENCE TO RELATED APPLICATION

This application claims the benefit of U.S. Provisional Application Ser. No. 62/501,914, filed by Shawn Whitson on May 5, 2017, entitled “SHORT RANGE ADVERTISING SYSTEM,” commonly assigned with this application and incorporated herein by reference.

### TECHNICAL FIELD

This disclosure relates to short range advertising and, more specifically, a short range advertising system which enables businesses to broadcast messages to potential customers near or about their business.

### BACKGROUND

Businesses have heretofore relied upon traditional print, electronic mail, and web advertising to publicize advertisements (ads) or special deals available for customers. Traditional print ads are sent via mass-mailings or in newspaper advertising bundles and generally not targeted to specific customers, as are web-based pop-ups or ads on websites.

Recently, technology development has made it easier for businesses to communicate ads and specials more directly with customers. For example, some businesses use electronic mail (e-mail) and text ads or messages for customers who agree to subscribe to such notices.

### SUMMARY

Disclosed herein are various aspects and components of short range advertising systems. In one aspect, there is disclosed an advertisement (ad) generator. The ad generator may comprise a user interface for receiving advertising inputs for at least one business, the advertising inputs at least including promotional information about the business; a processor configured to generate at least one advertisement (ad) for the business based on the promotional information; and a communication interface configured to receive a signal that includes at least one identifier of a short-range transmitter proximate a mobile communication device and associated with the business. The communication interface sends at least one generated ad to the mobile communication device, based on the received identifier, for display thereon.

In another aspect, there is disclosed an advertising system. The advertising system may include at least a short-range communication beacon associated with at least one business; and an advertisement (ad) generator. The ad generator may include at least a user interface for receiving advertising inputs from the at least one business, the advertising inputs at least including promotional information about the business; a processor configured to generate at least one advertisement (ad) for the at least one business based on the promotional information; and a communication interface configured to receive a signal that includes at least one identifier of the short-range transmitter proximate a mobile communication device and associated with the at least one business. The communication interface sends at least one generated ad to the mobile communication device, based on the received transmitter identifier, for display thereon.

In yet another aspect, there is disclosed a method for presenting advertisements on a mobile communication device, the method comprising at least providing a short-range communication beacon having an identifier to a business; and providing an ad generator. The ad generator may include at least a user interface for receiving advertising inputs for the business, the advertising inputs at least including promotional information about the business; a processor configured to generate at least one advertisement (ad) for the business based on the promotional information; and a communication interface configured to receive a signal that includes at least the identifier of the short-range communication beacon proximate a mobile communication device and associated with the business. The communication interface sends at least one generated ad to the mobile communication device, based on the received identifier, for display thereon.

### BRIEF DESCRIPTION

Reference is now made to the following descriptions taken in conjunction with the accompanying drawings, in which:

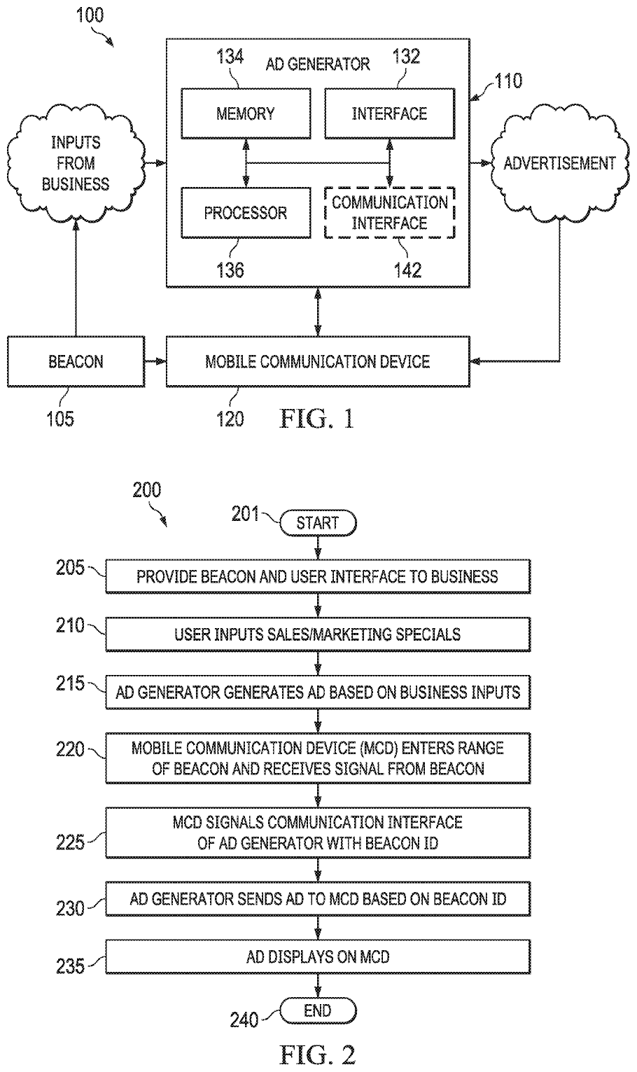

FIG. 1 illustrates a diagram of an embodiment of an ad generating system according to the principles of the disclosure;

FIG. 2 illustrates a flow diagram of an embodiment of a method for generating an ad for display on a mobile communication device according to the principles of the disclosure;

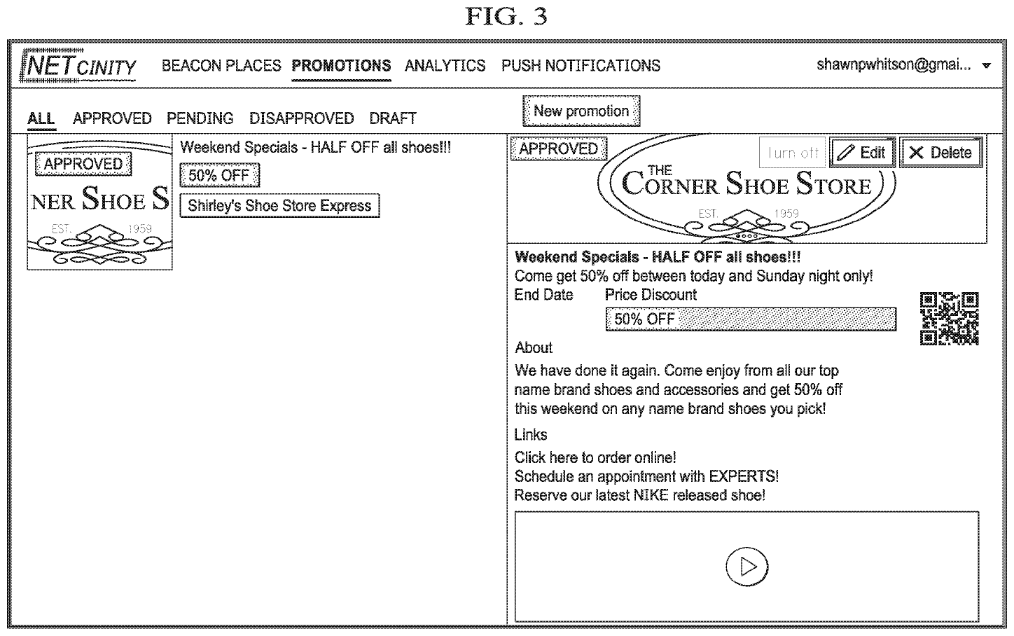

FIG. 3 illustrates one example of a user interface of an ad generator according to the principles of the disclosure;

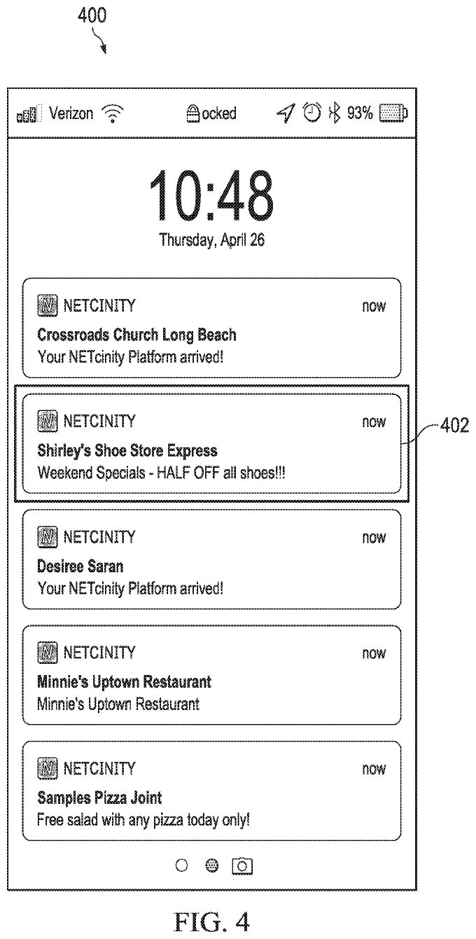

FIG. 4 illustrates an example of a “Home” screen which may display alerts of an ad generating system according to the principles of the disclosure;

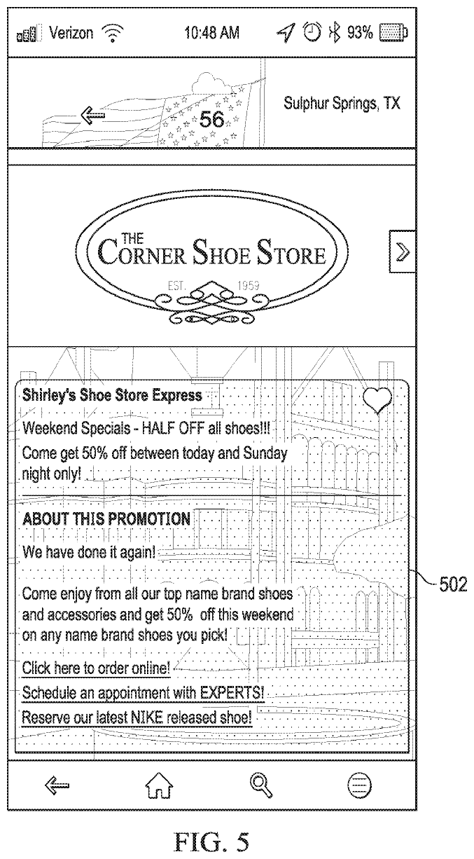

FIG. 5 illustrates one example of a business advertisement which may be displayed by an ad generating system according to the principles of the disclosure;

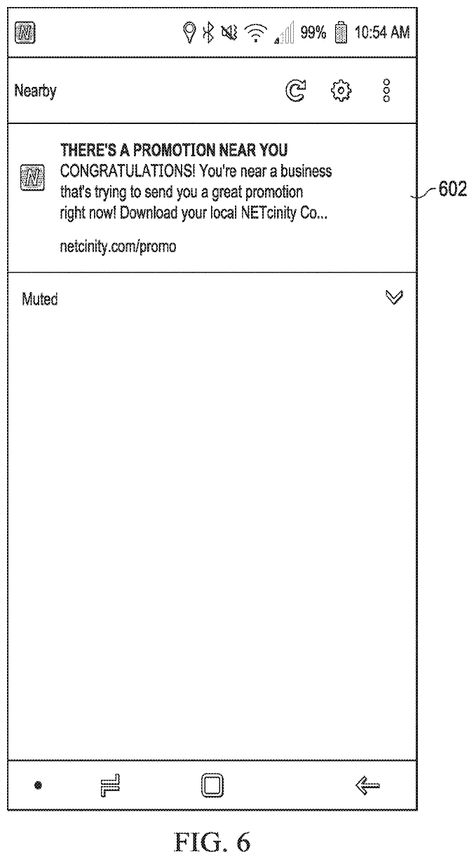

FIG. 6 illustrates a display which may be shown on a mobile communication device according to principles of the disclosure;

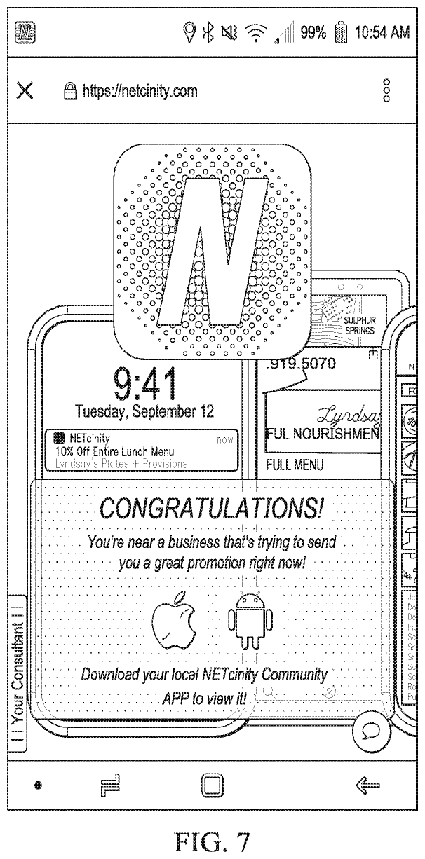

FIG. 7 illustrates another example of a display which may be shown on a mobile communication device according to principles of the disclosure;

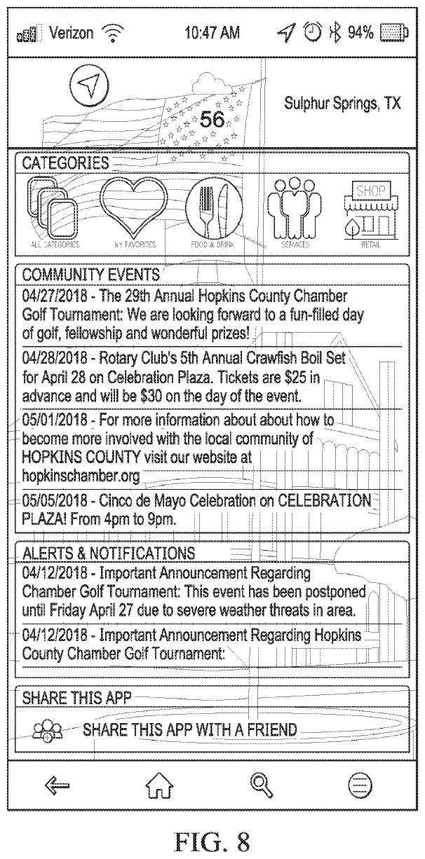

FIG. 8 is an example of a community home screen which may be generated and displayed on a mobile communication device by an ad generating system according to principles of the disclosure; and

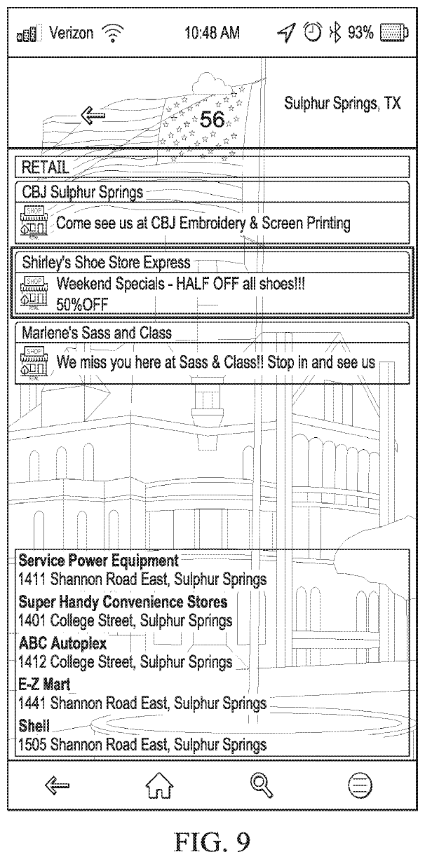

FIG. 9 illustrates another example of a community screen which may be generated and displayed on a mobile communication device by an ad generating system according to principles of the disclosure.

### DETAILED DESCRIPTION

Businesses use various advertising and marketing tools to reach as many customers as possible. Paper ads and circulars have been widely used to advertise special prices and sales, but are only effective when a customer picks up and reads through them, which can be time consuming. Paper coupons or specials have also been used for sales and special pricing, but a customer generally needs to remember to bring such an ad. As may often occur, a potential customer passes by a business and did not originally plan on entering the business, but if a customer learns of a special offer or sale, the customer may then decide to enter the business.

Recent developments in technology have enabled businesses to reach more customers via e-mails, web ads, and text ads. Web ads are similar to paper ads and circulars in that a customer must take the time to search for them in some cases, and then take the time to read through them, sort them, and be able to recall them when conducting a transaction with a business. While e-mail and text messages may be easier for a customer to access when conducting a transaction, a customer generally needs to authorize a subscription to the business's communications or text alerts, requiring the customer to provide at least their e-mail and/or mobile telephone number, or other contact information to each business for which a customer subscribes. Recent data breaches and privacy concerns have created concern regarding the safety and security of customer contact and financial data. Businesses must maintain and secure their customer database to ensure contact information is updated and privacy concerns are addressed. In addition, the business must create and generate the advertisements, or retain an advertising or e-mail service, such as, e.g. “Constant Contact,” to send the advertisement e-mails and texts, and the advertisement e-mails and texts are only as good as the contact information entered.

Accordingly, the disclosure provides an advertisement (ad) generating system using short-range beacons associated with businesses. An ad generator generates ads or promotional alerts based on advertising inputs from a user associated with a business and transmits the ad notifications to mobile telephones that have passed within communication range of the beacon for display thereon without a potential customer having to share their e-mail, phone number, or any other contact information in order to receive the notification. The ad notification may display on a mobile telephone, similar to other notification alerts. For example, Business A is having a “buy one, get one free” special on product A. As a mobile communication device enters the range of the short-range beacon, associated, physically located with, or located near Business A, the mobile communication device receives the beacon's signal, including its beacon identifier (ID).

If the mobile communication device has an advertising application installed or operates with certain mobile operating platforms, the mobile communication device communicates with the ad generating system and transmits at least the beacon's ID. The ad generating system receives the signal and identifies a generated ad associated with the beacon ID for Business A and sends the generated ad to the mobile communication device for display thereon. If the mobile communication device does not have an advertising application installed thereon, a Uniform Resource Locator (URL), commonly referred to as a web link or web address, received from the beacon may be displayed such that the potential customer may be able to download the application and/or directly access the ad or promotional information by accessing the URL.

An ad generating system according to the disclosure may include a computer program product configured to generate an ad based on a plurality of inputs and communicate the generated ad to a mobile communication device for display thereon according to details of the disclosure.

As discussed herein, an ad or advertisement, may include any marketing, sale, and/or promotional information and may also include community events and/or information. A business may include any retail, commercial, or government entity and/or any community organization, non-profit group or organization, and any other organized entity.

Turning now to the figures, FIG. 1 illustrates a diagram of an embodiment of an ad generating system 100 constructed according to the principles of the disclosure. The ad generating system 100 is configured to allow a user, such as an owner or employee at a business to interface with the system 100 in order to enter advertising or promotional information, such as sales, marketing information, timed offers, and/or specials currently offered or to be offered at the business. The business is provided a beacon 105 for association with the business and may be placed within or near the business's physical location. In some embodiments, the beacon 105 may be associated with or shared by multiple businesses, such as in a shopping center, or central community area. In some embodiments, there may be more than one beacon 105 or a group of beacons associated with the business. The beacon 105 may be a short-range communication beacon, such as, e.g., a BLUETOOTH® equipped beacon, and may use BLUETOOTH® low energy (BLE) technology, which uses less power and therefore consumes less energy than traditional BLUETOOTH® or other short-range communication technologies. The beacon 105 is identified by a unique identifier (ID) which identifies the beacon to other electronic devices, such as ad generator 110 and mobile communication device 120.

The ad generating system 100 includes ad generator 110 having at least a first interface 132 for receiving one or more inputs from a user at a business. In some embodiments, the interface 132 may also receive inputs from another user which may be designing or configuring a display based on the inputs from the user at a business. The system 100 may also include a communication interface 142 for communicating with mobile communication device 120. In some embodiments, the communication interface 142 may be a component of interface 132.

The user at a business, such as Business A, may use any computing device or user interface configured to communicate with interface 132 of the ad generator 110 in order to provide inputs related to sales and/or marketing specials to be advertised to mobile devices within range of the beacon 105, and accordingly, within a relatively similar distance from Business A. In one embodiment, the user at Business A communicates with the ad generator 110 via a web-based log-in system. The sales or specials may be date and/or time specific, so the user at Business A may log in to the interface 132 and update details and offers accordingly. The ad generator 110 receives the inputs and generates an ad to be displayed on any mobile device entering within a communication range of beacon 105, and thus, potential customers of Business A. In one embodiment, the communication range of beacon 105 may be about 260 ft., but other ranges may be accomplished or available in other embodiments. The user may interface with the ad generator 110 via a conventional communication device such as a smart phone, a tablet, a pad, a laptop, a desktop, or another device capable of interfacing with a user and communicating via wireless connections, wired connections or a combination thereof. The user may also interface with the ad generator 110 via a web-based interface. In some embodiments, the user may also include a third party, such as an employee associated with the ad generator 110 who may prepare and input promotional data.

The ad generator 110 may include at least one interface 132, a memory 134 and a processor 136. The ad generator 110 or at least a portion thereof can be embodied as a series of operating instructions stored on a non-transitory computer-readable medium that direct the operation of a processor when initiated. The ad generator 110 can be stored on a single computer or on multiple computers. The various components of the ad generator 110 can communicate via wireless or wired conventional connections. A portion of the ad generator 110 can be located on a server and other portions of the content provider 110 can be located on a computing device or devices that are connected to the server via a network or networks. In some embodiments, the ad generator 110 may be housed on a network, or may be stored at another computer storage facility. In one embodiment, the ad generator 110 is implemented on a server that includes the necessary logic and memory to perform the functions disclosed herein. Accordingly, the ad generator 110 can also be a website hosted on a web server, or servers, and that is accessible via the World Wide Web. A Uniform Resource Locator (URL) can be used to access various webpages of the ad generator 110.

The interface 132 is a component or device interface configured to couple the ad generator 110 to a user at Business A and receive inputs therefrom. The memory 134 is configured to store the various software aspects related to the ad generator 110. Additionally, the memory 134 is configured to store the various software aspects related to the ad generator 110. Additionally, the memory 134 is configured to store a series of operating instructions that direct the operation of the processor 136 when initiated. The memory 134 is a non-transitory computer readable medium. The memory 134 can be the memory of a server.

The processor 136 is configured to direct the operation of the ad generator 110. As such, the processor 136 includes the necessary logic to communicate with the interface 132 and the memory 134 and perform the functions described herein to generate an ad based on a plurality of inputs received by the ad generator 110. The processor 136 can be part of a server.

A communication interface 142 may be a second interface, or may be incorporated into interface 132. The communication interface 142 is configured to communicate with mobile communication device 120, mobile communication device 120 including any mobile device which is in communication range of beacon 105. Mobile communication device 120 is a wireless communication and computing device capable of both voice and data communication may be a mobile telephone, tablet, pad, or any personal communication device configured for short-range and long-range communication.

In one embodiment, the mobile communication device 120 may be a mobile phone configured for long-range wireless communication, including, but not limited to Long-term evolution (LTE) communications technology, Fourth Generation (4G) communications technologies, and Third generation (3G) communication technologies. In other embodiments, the mobile communication device 120 may be a handheld communication device that is only equipped for short-range wireless communication, such as, e.g., a tablet equipped with only short-range connectivity, such as Wi-Fi, and not configured for long-range communication. The mobile communication device 120 may include in its operating system, a short-range communication device search and discovery tool, such as “BLUTOOTH® Discovery Mode” on APPLE® platforms and a physical web interface, or “Nearby Notifications” on GOOGLE® and ANDROID® platforms. If short-range communication such as BLUETOOTH® is turned on, the device is constantly searching for BLUETOOTH® enabled devices, and as such, receives the beacon's ID when entering within the range of the beacon.

When mobile communication device 120 enters within the communication range of beacon 105, the beacon 105 transmits a signal to the mobile communication device 120. The signal includes at least a beacon identifier (ID). The signal may also include additional data fields, including a URL. The URL may be the web link to download and install a promotional application onto the mobile communication device, or in sme embodiments, the URL may be associated with the business so the customer may directly access a web site associated with the business. The additional data fields may include a title, a subtitle, and a description. For example, the title may include the business name, the subtitle may indicate that the customer is near a promotion, and a description may give a direction to click or access the provided URL to access the promotion or ad.

If the mobile communication device 120 has an advertising application installed, a communication interface capable of detecting a short-range beacon signal, such as, e.g. a physical web interface, built into the operating system of mobile communication device 120, detects the beacon ID and sends a signal to the ad generator 110, the signal including the beacon ID. The ad generator 110 processes the received signal and beacon ID and determines which business and beacon the mobile communication device is near. For example, mobile communication device 120 is near Business A, so ad generator 110 sends or pushes the ad associated Business A and Business A's beacon to the mobile communication device 120 for display thereon. The operating system within the mobile communication device 120 receives the ad and displays the ad on mobile communication device 120. In some embodiments, the mobile communication device may be configured to provide an audible or tactile alert in addition to the visual alert with the ad information.

In some embodiments, an application (app) may installed and executed on the mobile communication device 120, the app configured to display alerts and ads on the display of mobile communication device 120. In some embodiments, if the mobile communication device 120 does not have the app installed, an alert may display on the mobile communication device 120 that a promotion or sale is being offered at a nearby business and prompt the user to download and install the app for further information regarding the sale or promotion. In some embodiments, the app executes a command on the mobile communication device 120 to communicate with the ad generator to retrieve the nearby sales and promotions.

In one example, an advertising app, such as a “Netcinity” app available on most mobile communication device operating platforms is configured to execute commands on mobile communication device 120 to connect mobile communication device 120 with the ad generator and send the beacon id, and then process an ad received from the ad generator for display on mobile communication device 120.

In some examples where an advertising app such as “Netcinity” is not installed, the processor of the mobile communication device 120 may include command instructions such as “Nearby Notification” or another physical web interface to receive signal from the beacon 105, including beacon id and additional data, and generate an alert on mobile communication device 120, notifying the user that a nearby business has an ad and alert the user to download and install the app. In other embodiments, the alert may include a URL though which the customer can access the ad by linking directly to the URL without downloading the app.

In one embodiment, the physical web interface may be an application (app) installed on the mobile communication device 120. In other embodiments, the physical web interface may be incorporated with the operating system of either the mobile communication device 120 and/or another app installed on the mobile devices. In one embodiment, the physical web interface may be incorporated with and supported by the GOOGLE CHROME® app, which is installed on many phones. In another embodiment, the physical web app may be supported by an APPLE® operating system and/or web browser.

In some embodiments, the advertising app may be configured to display information related to one or more local communities in which the holder of the mobile communication lives or works. The local community ad app may be configured to communicate with the ad generator 110 and display at least one ad received from the ad generator on the mobile communication device 120 while the display screen is “locked” and not actively in use at the time the ad is received. An example of such a locked screen is shown hereinafter in FIG. 4.

In other embodiments, the beacon 105 may be associated with more than one business. For example, a shopping center may a few businesses that would like to alert nearby shoppers to sales and promotions. The ad generator 110 may recognize that the beacon ID has more than one business associated and may be configured to send multiple ads to the mobile communication device.

In other embodiments, the ad generator 110 may be configured to communicate with a payment app installed on mobile communication device 120, such as e.g. APPLE WALLET®, GOOGLE WALLET®, PAYPAL®, and other payment apps which may be available and installed on the mobile communication device 120.

In other embodiments, the system 100 may include an app which may be developed and created specifically for a user, such as Business A, which includes additional information regarding Business A in addition to ads, specials, and other subject matter which may be included in the generated ad.

Turning now to FIG. 2, there is illustrated an embodiment of a method 200 for generating an ad for display on a mobile communication device according to aspects of the disclosure. In one embodiment, at least a portion of the method 200 can be performed by a computing device as disclosed herein. A computing device may include the necessary logic circuitry to carry out the method 200. In one embodiment, the method 200 or at least a portion thereof may be embodied as a series of operating instructions that are stored on a non-transitory computer readable medium and used to direct the operation of a processor when initiated thereby. The method 200 begins in a step 201.

In a step 205, a short-range communication beacon is provided to a user, along with access to an interface to communicate inputs with an ad generator. The beacon has a unique transmitter identifier that may be assigned to the user's business by the ad generator.

In a step 210, the user may input advertising information, such as sales and/or marketing specials, time periods for the sales and/or marketing specials, and other inputs which may affect how and when an ad is presented.

In a step 215, the ad generator receives the advertising inputs and generates at least one ad based on the received inputs. The ad may be displayed on any mobile communication device which enters within a communication range of the beacon.

In a step 220, a mobile communication device enters the communication range of the beacon and receives a signal from the beacon, the signal including at least the beacon's ID.

In a step 225, the mobile communication device communicates with the ad generator and transmits at least the beacon ID to the ad generator.

In a step 230, the ad generator receives the signal including the beacon ID and sends an ad back to the mobile communication device according to the beacon ID.

In a step 235, the mobile communication receives the ad. In some embodiments, the ad is displayed on a display of the mobile communication device. In some embodiments, an advertising app may be installed on the mobile communication device, the app configured to execute instructions for communicating with the ad generator and displaying ad received from the ad generator on the mobile communication device. In some embodiments, where an advertising app is not installed on the mobile communication device, an alert may inform the holder of the mobile communication device know that there are businesses nearby having promotions, whereafter the mobile communication device holder may choose to download and install the advertising app. In some embodiments, the mobile communication device may receive a URL along with the beacon ID such that the holder may link directly to the business's website or promotional data via the URL. The mobile communication device may also be configured to alert the user via an audible or tactile signal, according to the settings on the mobile communication device.

In some embodiments, the ad may include a link enabling the holder of the mobile communication device to take further action. The link may include several additional options to be taken, including, but not limited to placing an online order, reserving an item(s), placing a seating reservation for business such as restaurants, making an appointment or similar reservation for service providers, and several other content options that may be presented by text, video, QR codes, and address and contact information included in the ad. For example, a restaurant such as Minnie's Uptown Restaurant may provide a link such that the holder of the mobile communication device may make a reservation for a meal. In another example, the holder of the mobile communication device may decide to place an online order with Shirley's Shoe Store Express. In yet another example, the holder of the mobile communication device may decide to place an order with Joe's Pizza for pickup. Accordingly, examples could include any reservation or online transaction that may be accomplished using a mobile communication device such as a smartphone and the like.

The method ends at a step 240.

Referring now to FIG. 3, there is shown an example of a screen 300 of a user interface which may be used by a user or programmer to interface with an ad generator such as ad generator 110. The user may be a user at a business, or may be a third party user or programmer tasked with using a processor, such as processor 136 to create an ad for display on a mobile communication device. Inputs may include the business name, beacon identifier for a beacon located at or near the business, sale or promotional information, community information, business contact information, duration of the sale or promotion, and various other information which a business may want to be displayed to potential customers.

Referring now to FIG. 4, there is shown one example of a “Home” screen 400 on a mobile communication device, which may show alerts regarding nearby promotions, sales, and other important information which may be provided on a “home” screen of a mobile communication device. As shown, an alert 402 may provide a specific business and information regarding a sale or promotion. Other alerts, not shown, my include typical alerts shown on a mobile communication device such as missed calls, text alerts, and other various alerts. The “Home” screen 400 shown in FIG. 4 is for a mobile communication device having an app, such as “Netcinity,” installed thereon, wherein the app executes on a processor within the mobile communication device to communicate with an ad generator such as ad generator 110 to send a beacon ID and receive sales and information generated by the ad generator and thereafter display the received ads on the mobile communication device.

Referring now to FIG. 5, there is shown a vendor alert 502 which may be displayed on the mobile communication device. As shown in alert 502, a promotional event is displayed and provides, in this example, a time limit for the promotion. In addition, this ad provides a plurality of links whereby the holder of the mobile communication device may take further action. In this ad, for example, there are three links which provide for the following: 1) placing an order online; 2) reserving an appointment with personnel in the store; and 3) reserving merchandise, such as a pair of athletic shoes. Also included in the ad display is a community in which the business is located in or associated with is displayed. In this example, the city of Sulphur Springs, is displayed, along with weather information, such as temperature and clouds/precipitation, etc. Hereinafter, in FIG. 8, an example of a community home screen will be provided.

Referring now to FIG. 6, there is shown an example of an alert which may be displayed on a mobile communication device that does not have an advertising app, such as “Netcinity,” installed thereon. In most mobile communication device operating systems enabled for short-range (such as BLUTOOTH®) communications, there is a short-range communication device search and discovery tool, such as “BLUTOOTH® Discovery Mode” on APPLE® platforms and a physical web interface, or “Nearby Notifications” on GOOGLE® and ANDROID® platforms, that is constantly searching for short-range communication devices, similar to BLUETOOTH® beacons. If the short-range communication mode is enabled on the mobile communication device and the mobile communication device enters within a communication range of a beacon at a business, the mobile communication device will detect the signal from the beacons and receive its beacon identifier. If an advertising app is not installed on the mobile communication device, the processor of the mobile communication device will generate an alert for display on the device. As shown in the alert 602, the alert may include at least a Title, an icon for the advertising app, a description that a promotion is nearby, and a uniform resource locator (URL) through which the advertising app may be downloaded in order to view and access the promotion or business information.

Referring now to FIG. 7, there is shown another example of an alert 702 which may be displayed on a mobile communication device when the mobile communication receives a signal from a short range transmitter, such as a beacon.

Referring now to FIG. 8, there is shown an example of a community “home” screen which may be on a mobile communication device having an advertising app such as “Netcinity,” installed thereon. The home screen may be generated by an ad generator such as ad generator 110 based on inputs from either a user at the business or a user with programming or input access to the ad generator. The inputs may be specific for each community and may include automated inputs from a weather service for the community, local events, news alerts, community and business ads, and any other inputs which may be desired for business and app users in each community.

Referring now to FIG. 9, there is shown another example of a community “home” screen which may be displayed on a mobile communication device having an advertising app, such as “Netcinity,” installed thereon. In the example shown, the alerts and information are arranged by categories. As seen in FIGS. 8 and 9, the alerts and information may contain a number of different types of information and may be displayed in any number of arrangements or configurations.

A portion of the above-described apparatus, systems or methods may be embodied in or performed by various, such as conventional, digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

In one aspect, an advertisement (ad) generator may comprise a user interface for receiving advertising inputs for at least one business, the advertising inputs at least including promotional information about the business; a processor configured to generate at least one advertisement (ad) for the business based on the promotional information; and a communication interface configured to receive a signal that includes at least one identifier of a short-range transmitter proximate a mobile communication device and associated with the business. The communication interface sends at least one generated ad to the mobile communication device, based on the received identifier, for display thereon.

In another aspect, an advertising system may include at least a short-range communication beacon associated with at least one business; and an advertisement (ad) generator. The ad generator may include at least a user interface for receiving advertising inputs from the at least one business, the advertising inputs at least including promotional information about the business; a processor configured to generate at least one advertisement (ad) for the at least one business based on the promotional information; and a communication interface configured to receive a signal that includes at least one identifier of the short-range transmitter proximate a mobile communication device and associated with the at least one business. The communication interface sends at least one generated ad to the mobile communication device, based on the received transmitter identifier, for display thereon.

In yet another aspect, a method for presenting advertisements on a mobile communication device include at least providing a short-range communication beacon having an identifier to a business; and providing an ad generator. The ad generator may include at least a user interface for receiving advertising inputs for the business, the advertising inputs at least including promotional information about the business; a processor configured to generate at least one advertisement (ad) for the business based on the promotional information; and a communication interface configured to receive a signal that includes at least the identifier of the short-range communication beacon proximate a mobile communication device and associated with the business. The communication interface sends at least one generated ad to the mobile communication device, based on the received identifier, for display thereon.

Any of the foregoing aspects may include at least or more of the following elements:
a) wherein the ad is configured for display through a mobile application (app) installed on the mobile communication device;
b) wherein the user is a third party not associated with the business;
c) wherein the signal further includes a Uniform Resource Locater (URL);
d) wherein the URL includes a link to install a mobile application (app) on the mobile communication device;
e) wherein the URL includes promotional information about the business;
f) wherein the processor is further configured to prepare a community display for display on the mobile communication device based on the inputs; and
g) providing a mobile application (app) for installation and operation on the mobile communication device, the app configured to display the at least one generated ad.

Those skilled in the art to which this application relates will appreciate that other and further additions, deletions, substitutions and modifications may be made to the described embodiments.

1. An advertisement generator, comprising:
a user interface for receiving advertising inputs for at least one business, the advertising inputs at least including promotional information about the business;
a processor configured to execute a series of operating instructions to generate at least one advertisement (ad) for the business based on the promotional information; and
a communication interface configured to receive a signal that includes at least one identifier of at least one short-range transmitter associated with the at least one business, and detect when a a mobile communication device is proximate the at least one short-range transmitter;
wherein the communication interface sends at least one generated ad to the mobile communication device, based on the received at least one identifier, for display on the mobile communication device.

2. The advertisement generator according to claim 1, wherein the ad is configured for display through a mobile application (app) installed on the mobile communication device.

3. The advertisement generator according to claim 1, wherein the user is a third party not associated with the business.

4. The advertisement generator according to claim 1, wherein the signal further includes a Uniform Resource Locater (URL).

5. The advertisement generator according to claim 4, wherein the URL includes a link to install a mobile application (app) on the mobile communication device.

6. The advertisement generator according to claim 4, wherein the URL includes promotional information about the business.

7. The advertisement generator according to claim 1, wherein the processor is further configured to prepare a community display for display on the mobile communication device based on the inputs.

8. An advertising system, the system comprising:
a short-range communication beacon associated with at least one business and having an identifier; and
an ad generator, the ad generator comprising:
a user interface for receiving advertising inputs for the business, the advertising inputs at least including promotional information about the business;
a processor configured to execute a series of operating instructions to generate at least one advertisement (ad) for the business based on the promotional information; and
a communication interface configured to receive a signal that includes at least one identifier of at least one short-range transmitter associated with the at least one business, and detect when a mobile communication device is proximate the at least one short-range transmitter;
wherein the communication interface sends at least one generated ad to the mobile communication device, based on the received at least one identifier, for display on the mobile communication device.

9. The advertising system according to claim 8, further comprising an application (app) for installation and execution on the mobile communication device, wherein the ad is displayed on the mobile communication device through the app.

10. The advertising system according to claim 8, wherein the user is a third party not associated with the business.

11. The advertising system according to claim 8, wherein the signal further includes a Uniform Resource Locater (URL).

12. The advertising system according to claim 11, wherein the URL includes a link to install a mobile application (app) on the mobile communication device.

13. The advertising system according to claim 11, wherein the URL includes promotional information about the business.

14. The advertising system according to claim 8, wherein the processor is further configured to prepare a community informational display for display on the mobile communication device based on the inputs.

15. A method for presenting advertisements on a mobile communication device, the method comprising:
providing a short-range communication beacon having an identifier to a business;
providing an ad generator, the ad generator comprising:
a user interface for receiving advertising inputs for the business, the advertising inputs at least including promotional information about the business;
a processor configured to execute a series of operating instructions to generate at least one advertisement (ad) for the business based on the promotional information; and
a communication interface configured to receive a signal that includes at least one identifier of at least one short-range transmitter associated with the at least one business, and detect when a mobile communication device is proximate the at least one short-range transmitter;
wherein the communication interface sends at least one generated ad to the mobile communication device, based on the received at least one identifier, for display on the mobile communication device.

16. The method for presenting advertisements on a mobile communication device according to claim 15, further comprising providing a mobile application (app) for installation and operation on the mobile communication device, the app configured to display the at least one generated ad.

17. The method for presenting advertisements on a mobile communication device according to claim 15, wherein the signal further includes a Uniform Resource Locater (URL).

18. The method for presenting advertisements on a mobile communication device according to claim 17, wherein the URL includes a link to install the mobile application (app) on the mobile communication device.

19. The method for presenting advertisements on a mobile communication device according to claim 17, wherein the URL includes promotional information about the business.

20. The method for presenting advertisements on a mobile communication device according to claim 15, wherein the inputs further include community information for a community in which the business is located and wherein the processor is further configured to prepare a community display for display on the mobile communication device based on the inputs.
